(19) United States
(12) Patent Application Publication
(10) Pub. No.: US 2023/0186400 A1
(43) Pub. Date: Jun. 15, 2023

(54) SYSTEMS AND COMPUTERIZED METHODS FOR LIVESTOCK MANAGEMENT

(71) Applicant: ZURICH SEGUROS ECUADOR S.A., Quito (EC)

(72) Inventors: Peter Sisulak, Quito (EC); Juan Xavier Bolaños Pozo, Quito (EC)

(73) Assignee: ZURICH SEGUROS ECUADOR S.A., Quito (EC)

(21) Appl. No.: 18/056,471

(22) Filed: Nov. 17, 2022

Related U.S. Application Data
(60) Provisional application No. 63/319,954, filed on Mar. 15, 2022.
(60) Provisional application No. 63/289,849, filed on Dec. 15, 2021.

(51) Int. Cl. G06Q 40/08; A01K 29/00; G06V 40/10; H03M 7/12

(52) U.S. Cl. CPC G06Q 40/08; A01K 29/005; G06V 40/10; H03M 7/12

(57) ABSTRACT

A method includes receiving, by a client application executing on a mobile computing device, livestock information, the livestock information including one or more of information about a livestock facility or information about items of livestock at the livestock facility. The method also includes capturing, by the client application, images of the items of livestock at the livestock facility. Further, the method includes determining an identification of one of the items of livestock based at least partially on an analysis of one or more of the images that were captured. The method includes transmitting, by the client application, the livestock information, the images to an insurance server system, and the identification.

### RELATED APPLICATIONS

The present application claims the benefit of U.S. Provisional Patent Application No. 63/289,849 filed Dec. 15, 2021, entitled “Livestock Insurance Platform”, and U.S. Provisional Patent Application No. 63/319,954 filed Mar. 15, 2022, entitled “COMPUTERIZED METHOD FOR LIVESTOCK MANAGEMENT”, which are hereby incorporated herein by reference in their entirety herein.

### BACKGROUND

The raising of livestock is essential to meet the nutritional needs of the earth's population. Although some domesticated animals, such as poultry, can be raised relatively quickly, cattle require a relatively long time to mature and a correspondingly large investment before the cattle can be sold. Accordingly, cattle are often insured to mitigate losses due to disease, predation, accidents, lightning strikes, or other causes.

It would therefore be an advancement in the art to facilitate the insurance of livestock.

### SUMMARY

According to embodiments of the present disclosure, a method includes receiving, by a client application executing on a mobile computing device, livestock information, the livestock information including one or more of information about a livestock facility or information about items of livestock at the livestock facility. The method also includes capturing, by the client application, images of the items of livestock at the livestock facility. Further, the method includes determining an identification of one of the items of livestock based at least partially on an analysis of one or more of the images that were captured. The method includes transmitting, by the client application, the livestock information, the images to an insurance server system, and the identification.

In an embodiment, determining an identification includes transmitting the one or more of the images to the insurance server system; and receiving, from the insurance server system, the analysis of the one or more images.

In an embodiment, the method includes (a) determining, by the client application, that the mobile computing device is not connected to a network; and in response to (a), storing, by the client application, the livestock information and the images on the mobile computing device. The method also includes (b) determining, by the client application, that the mobile computing device has connected to the network; and transmitting the livestock information and the images to the insurance server system is in response to (b).

In an embodiment, transmitting the livestock information and the images to the insurance server system includes transmitting a document including the livestock information and the images, where the document is a portable document format (PDF) document.

In an embodiment, transmitting the images to the insurance server system includes processing the images to obtain reduced quality images and transmitting the reduced quality images to the insurance server system.

In an embodiment, the reduced quality images are included in the document as base64 encoded text.

In an embodiment, capturing the images of the livestock referenced by the livestock information includes disabling, by the client application, upload of images stored on the mobile computing device; and capturing, by the client application, the images of the livestock referenced by the livestock information while upload of images stored on the mobile computing device is disabled.

In an embodiment, the method includes evaluating, by the client application, an amount of memory available on the mobile computing device. The method also includes (a) determining, by the client application, that the amount of memory is less than a threshold; and in response to (a), limiting, by the client application a number of items of livestock that can be referenced by the livestock information and the images.

In an embodiment, the method includes capturing a location of the mobile computing device while capturing the images of the livestock referenced by the livestock information.

According to additional embodiments of the present disclosure, a non-transitory computer-readable medium stores executable code that, when executed by one or more processing devices causes the one or more processing devices to receive, by a client application, livestock information. The executable code causes the one or more processing devices to initiate capture of images of livestock referenced by the livestock information. The executable code causes the one or more processing devices to in response to, initiating capture, disabling, by the client application, upload of stored on a mobile computing device to the client application. The executable code causes the one or more processing devices to capture, while image upload is disabled, images of livestock referenced by the livestock information. The executable code causes the one or more processing devices to transmit, by the client application, the livestock information and the images to an insurance server system.

In an embodiment, the executable code, when executed by the one or more processing devices further causes the one or more processing devices to (a) determine, by the client application, that the one or more processing devices are not connected to a network; in response to (a), store, by the client application, the livestock information and the images referenced by the livestock information on a storage device connected to the one or more processing devices; (b) determine that the one or more processing devices are connected to the network; and transmit the livestock information and the images to the insurance server system in response to (b).

In an embodiment, the executable code, when executed by the one or more processing devices further causes the one or more processing devices to transmit the livestock information and the images to the insurance server system by transmitting a document including the livestock information and the images, where the document is a portable document format (PDF) document.

In an embodiment, the executable code, when executed by the one or more processing devices further causes the one or more processing devices to transmit the images to the insurance server system by processing the images to obtain reduced quality images and transmitting the reduced quality images to the insurance server system.

In an embodiment, the reduced quality images are included in the document as base64 encoded text.

In an embodiment, the executable code, when executed by the one or more processing devices further causes the one or more processing devices to evaluate, by the client application, an amount of memory available on a mobile computing device including the one or more processing devices; and if the amount of memory is less than a threshold, limit a number of items of livestock that can be referenced by the livestock information and the images.

In an embodiment, the executable code, when executed by the one or more processing devices further causes the one or more processing devices to capture a location of a mobile computing device while capturing the images of the livestock referenced by the livestock information, the one or more processing devices being included in the mobile computing device.

According to additional embodiments of the present disclosure, a mobile client device includes a communication device for communicating with an insurance server system via a network; one or more memory devices storing instructions; and one or more processing devices that execute the instructions to perform a method. The method includes receiving livestock information, the livestock information comprising one or more of information about a livestock facility or information about items of livestock at the livestock facility. The method also includes capturing, by an image capture device, images of the items of livestock at the livestock facility. The method further includes securely encoding the images of the items of livestock, wherein the encoding prevents alteration of the images. The method includes transmitting, via the network, the livestock information and the images to the insurance server system.

In an embodiment, the one or more processing devices execute the instructions to perform the method further including disabling, during capture of the images, upload of images stored on the one or more memory devices; and disabling, during capture of the images, the communication device.

In an embodiment, the one or more processing devices execute the instructions to perform the method further including determining an identification of one of the items of livestock based at least partially on an analysis of one or more of the images that were captured.

In an embodiment, the one or more processing devices execute the instructions to perform the method further including: (a) determining that communication on the network is not available; in response to (a), storing, by the client application, the livestock information and the images on the one or more memory devices; (b) determining, by the client application, that communication on the network is available; and transmitting the livestock information and the images to the insurance server system is in response to (b).

### BRIEF DESCRIPTION OF THE FIGURES

In order that the advantages of the present disclosure will be readily understood, a more particular description of the invention briefly described above will be rendered by reference to exemplary embodiment(s) illustrated in the appended drawings. Understanding that these drawings depict only typical exemplary embodiments of the subject disclosure and are not therefore to be considered limiting of its scope. The exemplary embodiments of the subject disclosure will be described and explained with additional specificity and detail through use of the accompanying drawings, in which:

FIGS. 1A and 1B are schematic block diagrams of components executing on a client device and server device in accordance with an exemplary embodiment of the present disclosure;

FIG. 2 is a schematic block diagram illustrating intake of livestock data by a client device in accordance with an exemplary embodiment of the present disclosure;

FIG. 3 is a schematic block diagram illustrating processing of claims for livestock losses in accordance with an exemplary embodiment of the present disclosure;

FIG. 4 is a schematic block diagram illustrating components on a client device to support intake of livestock data and claims in accordance with an exemplary embodiment of the present disclosure;

FIG. 5 is a schematic block diagram illustrating installation of a client application in accordance with an exemplary embodiment of the present disclosure;

FIG. 6 is a schematic block diagram illustrating acquisition of location data in accordance with an exemplary embodiment of the present disclosure;

FIG. 7 is a schematic block diagram illustrating secure capture of image data in accordance with an exemplary embodiment of the present disclosure;

FIG. 8 is a schematic block diagram illustrating pushing of content to client applications in accordance with an exemplary embodiment of the present disclosure; and

FIG. 9 is a schematic block diagram of a computer system suitable for implementing methods in accordance with exemplary embodiments of the present disclosure.

### DETAILED DESCRIPTION

Reference will now be made in detail to the various embodiments of the subject disclosure illustrated in the accompanying drawings. Wherever possible, the same or like reference numbers will be used throughout the drawings to refer to the same or like features. It should be noted that the drawings are in simplified form and are not drawn to precise scale. Certain terminology is used in the following description for convenience only and is not limiting. Directional terms such as top, bottom, left, right, above, below and diagonal, are used with respect to the accompanying drawings. The term “distal” shall mean away from the center of a body. The term “proximal” shall mean closer towards the center of a body and/or away from the “distal” end. The words “inwardly” and “outwardly” refer to directions toward and away from, respectively, the geometric center of the identified element and designated parts thereof. Such directional terms used in conjunction with the following description of the drawings should not be construed to limit the scope of the subject disclosure in any manner not explicitly set forth. Additionally, the term “a,” as used in the specification, means “at least one.” The terminology includes the words above specifically mentioned, derivatives thereof, and words of similar import.

“About” as used herein when referring to a measurable value such as an amount, a temporal duration, and the like, is meant to encompass variations of ±20%, ±10%, ±5%, ±1%, or ±0.1% from the specified value, as such variations are appropriate.

“Substantially” as used herein shall mean considerable in extent, largely but not wholly that which is specified, or an appropriate variation therefrom as is acceptable within the field of art. “Exemplary” as used herein shall mean serving as an example.

Throughout this disclosure, various aspects of the subject disclosure can be presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments of the subject disclosure can be combined in any suitable manner in one or more embodiments. One skilled in the relevant art will recognize, in light of the description herein, that the present disclosure can be practiced without one or more of the specific features or advantages of a particular exemplary embodiment. In other instances, additional features and advantages can be recognized in certain embodiments that can not be present in all exemplary embodiments of the subject disclosure.

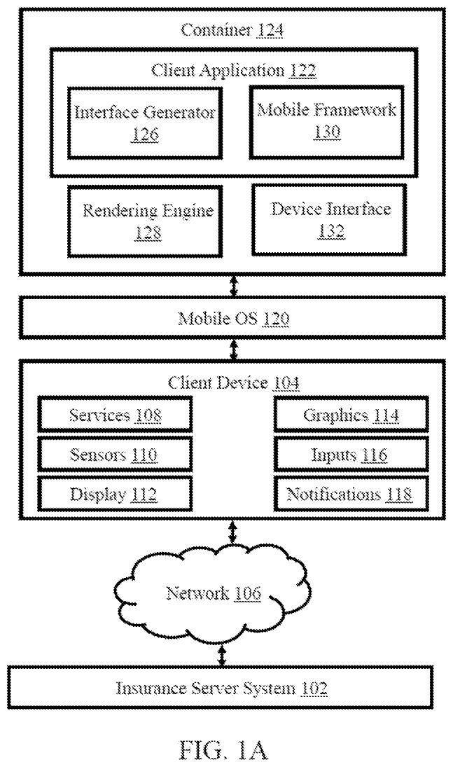

FIGS. 1A and 1B illustrate a network environment 100 to provide livestock management according to examples of the present disclosure. While FIGS. 1A and 1B illustrate various components contained in the network environment 100, FIGS. 1A and 1B illustrate one example of a network environment of the present disclosure, and additional components can be added and existing components can be removed.

Referring to FIG. 1A, a network environment 100 can include an insurance server system 102 operated by an entity providing livestock insurance, as further illustrated in FIG. 1 B. The network environment 100 can include a client device 104. The client device 104 can be a mobile computing device such as a smart phone, tablet computer, wearable computer, laptop computer, or other computing device. Although some of the approaches described herein are preferably performed by a mobile computing device, the client device 104 can also include a desktop computer or server computer in some embodiments.

The client device 104 can communicate with the insurance server system 102 by means of a network 106. The network 106 can include one or more wired or wireless networks, such as a cellular data network. The network 106 can include some or all of a local area network (LAN), wide area network (WAN), the Internet, or other network.

The client device 104 can include hardware, firmware, or software components for performing specialized tasks. For example, the client device can implement services 108, such as networking services, services providing access to a haptic device, speaker, camera, antennas, or other component of the client device 104, voice command detection and interpretation, and/or other services. The client device 104 can include sensors 110 such as a magnetic compass, inertial measurement unit (IMU), one or more cameras, one or more microphones, a global positioning system (GPS) receiver, or other sensors. The client device 104 can include a display 112, which can be embodied as a touch screen. The client device 104 can include a graphics engine 114 for rendering images. The client device 104 can include one or more input devices 116, such as one or more buttons, the touch screen of the display 112, or other input device. The client device 104 can also implement notifications 118 such that events received over a network or software executing on the device 104 can be captured and presented to the user of the client device 104.

The client device 104 can have a mobile operating system (OS) 120. The mobile operating system 120 can be iOS™, ANDROID™, or other mobile operating system. The methods and processes described herein can be implemented by a client application 122. The client application 122 can execute within a container 124. The container 124 itself can execute within the mobile operating system 120 or the mobile operating system 120 can also execute within the container 124.

In addition to the logic implementing the methods described below, the client application 122 can include an interface generator 126. The interface generator can generate code according to hypertext markup language (HTML), customized style sheets (CSS), JavaScript, or other language that can be rendered by a browser or other application.

The client application 122 can interact with a rendering engine 128. The rendering engine 128 can execute within the container 124. The rendering engine 128 can receive code generated by the interface generator 126 and render the code to obtain images for output on the display 112. The rendering engine 128 can function as a browser rendering a webpage including HTML code, CSS code, JavaScript code, or other code included in an interface.

The client application 122 can further include a mobile framework 130 that enables the client application 122 to interact with the insurance server system 102 and to perform functions associated with the mobile-specific components 108-118 of the client device 104. In some embodiments, the mobile framework 130 includes one or both of the IONIC framework and the CAPACITOR mobile framework.

The mobile framework 130 can interact with the client device 104 through a device interface 132. The device interface 132 can execute within the container 124. The device interface 132 can function as a layer that enables the client application 122 and interfaces generated by the interface generator 126 to function on the client device 104 embodied as a mobile device, such as a smartphone or tablet. The device interface 132 can further define functions for accessing some or all of the components 108-118 of the client device 104. In some embodiments, the device interface 132 is embodied as APACHE CORDOVA, which can be further extended by custom plugins to implement the methods described herein.

As illustrated in FIG. 1B, one or more of the client devices 104 can communicate with the insurance server system 102 via the network 106. For example, the one or more client devices 104 can be operated by insurance agents, adjusters, claims processors, and/or livestock facility personnel to perform the processes described herein. The insurance server system 102 can execute and operate one or more copies of a server application 105. The server application 105 is configured to operate in combination with the client application 122 to perform the processes described herein. The server application 105 can be configured to include the necessary logic, commands, instructions, and protocols to perform the processes and methods described herein. The server application 105 can be written in any type of conventional programming language.

The insurance server system 102 can include one or more computing systems or devices that are configured to implement the methods and processes, as described below. The computing systems or devices can be one more of any type of computing system capable of communicating with client devices 104 and executing the server application 105, such as servers, laptops, desktops, cloud computing services, and the like. The computing system and devices can include several hardware resources, which are used to execute the server application 105 such as processors, memory, network hardware, bandwidth, storage devices, etc., and a number of software resources, such as operating systems, application programs, software appliances, etc. The server application 105 can be stored in computer-readable storage devices or media (CD, DVD, hard drive, portable storage memory, etc.) whether local to the computing system and devices or remotely located. The insurance server system 102 can provide one or more application programming interfaces (APIs) to the server application 105 and any other service offered by the insurance server system 102.

In embodiments, the insurance server system 102 can be implemented using physical computer systems, cloud computing services 150, and combinations thereof. In any embodiment, the insurance server system 102 can include one or more servers such as application servers, database servers, and data servers, whether physical and/or virtual. For example, one or more copies of the application 122 and/or the server application 105 can be instantiated in the cloud computing services 150 for use by one or more client devices 104. As used herein, a “cloud” or “cloud computing service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

The communication links by which the client devices 104 and the insurance server system 102 communicate can be direct or indirect. A direct link can include a link between two devices where information is communicated from one device to the other without passing through an intermediary. For example, the direct link can include a Bluetooth™ connection, a Zigbee® connection, a Wifi Direct™ connection, a near-field communications (NFC) connection, an infrared connection, a wired universal serial bus (USB) connection, an ethernet cable connection, a fiber-optic connection, a firewire connection, a microwire connection, and so forth. In another example, the direct link can include a cable on a bus network. “Direct,” when used regarding the communication links, can refer to any of the aforementioned direct communication links. An indirect link can include a link between two or more devices where data can pass through an intermediary, such as a router, before being received by an intended recipient of the data. For example, the indirect link can include a wireless fidelity (WiFi) connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long term evolution (LTE) standard, and so forth. “Indirect,” when used regarding the communication links, can refer to any of the aforementioned indirect communication links.

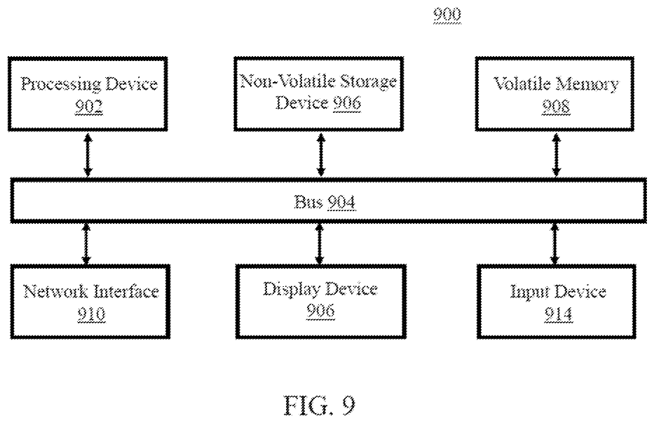

In embodiments, as described below in FIG. 9, various components of the client devices 104 and/or the insurance server system 102 can include data storage and/or processing capabilities. Such capabilities can be rendered by various electronics for processing and/or storing electronic signals. For example, the client devices 104 and/or the insurance server system 102 can include one or more processing devices and one or more memory devices. The processing device can be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” can be used generically to refer to any or all of the aforementioned specific devices, elements, and/or features of the processing device. The memory device can be and/or include a computer processing unit register, a cache memory, a magnetic disk, an optical disk, a solid-state drive, and so forth. The memory device can be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device.

In embodiments, the client devices 104 and/or the insurance server system 102 can include data communication capabilities. Such capabilities can be rendered by various electronics for transmitting and/or receiving electronic and/or electromagnetic signals. For example, the client devices 104 and/or the insurance server system 102 can include one or more communication devices. The communication device can include, for example, a networking chip, one or more antennas, and/or one or more communication ports. The communication device can generate radio frequency (RF) signals and transmit the RF signals via one or more of the antennas. The communication device can receive and/or translate the RF signals. The communication device can transceive the RF signals. The RF signals can be broadcast and/or received by the antennas. The communication device can generate electronic signals and transmit the RF signals via one or more of the communication ports. The communication device can receive the RF signals from one or more of the communication ports. The electronic signals can be transmitted to and/or from a communication hardline by the communication ports. The communication device can generate optical signals and transmit the optical signals to one or more of the communication ports. The communication device can receive the optical signals and/or can generate one or more digital signals based on the optical signals. The optical signals can be transmitted to and/or received from a communication hardline by the communication port, and/or the optical signals can be transmitted and/or received across open space by the networking device.

The communication device can include hardware and/or software for generating and communicating signals over a direct and/or indirect network communication link. For example, the communication component can include a USB port and a USB wire, and/or an RF antenna with Bluetooth™ programming installed on a processor, such as the processing component, coupled to the antenna. In another example, the communication component can include an RF antenna and programming installed on a processor, such as the processing device, for communicating over a Wifi and/or cellular network. As used herein, “communication device” “communication component,” and/or “communication unit” can be used generically herein to refer to any or all of the aforementioned elements and/or features of the communication component.

Various of the elements in the actuarial system 100 can be referred to as a “server.” Such elements can include a server device. The server device can include a physical server and/or a virtual server. For example, the server device can include one or more bare-metal servers. The bare-metal servers can be single-tenant servers or multiple tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers. The term server can refer to functionality of a device and/or an application operating on a device. For example, an application server can be programming instantiated in an operating system installed on a memory device and run by a processing device. The application server can include instructions for receiving, retrieving, storing, outputting, and/or processing data. A processing server can be programming instantiated in an operating system that receives data, applies rules to data, makes inferences about the data, and so forth. Servers referred to separately herein, such as an application server, a processing server, a collaboration server, a scheduling server, and so forth can be instantiated in the same operating system and/or on the same server device. Separate servers can be instantiated in the same application or in different applications.

Various aspects of the systems described herein can be referred to as “data.” Data can be used to refer generically to modes of storing and/or conveying information. Accordingly, data can refer to textual entries in a table of a database. Data can refer to alphanumeric characters stored in a database. Data can refer to machine-readable code. Data can refer to images. Data can refer to audio. Data can refer to, more broadly, a sequence of one or more symbols. The symbols can be binary. Data can refer to a machine state that is computer-readable. Data can refer to human-readable text.

The insurance server system 102 can include one or more databases or database servers 103 for storing data used by the insurance server system 102 and/or the client devices 104. The databases or database servers 103 can be implement using any database technology. The database can be a database according to GOOGLE FIREBASE, ORACLE, SQL, MYSQL, DB2, or other database technology.

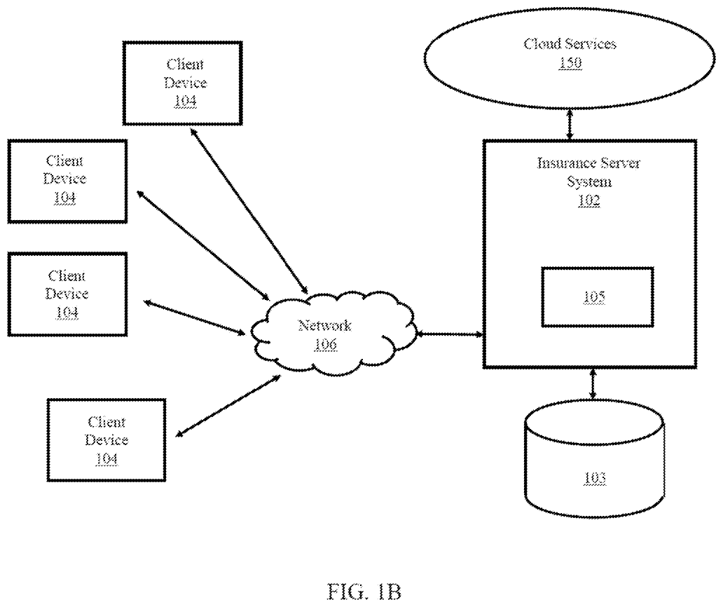

FIG. 2 illustrates a method 200 for facilitating the intake of livestock information. The method 200 can enable the capture of insurance data by a user in remote places thereby reducing the cost to insure livestock. While FIG. 2 illustrates several steps, stages, and/or processes that can be performed in method 200, the steps, stages, and/or processes can be performed in any order, and additional steps, stages, and/or processes can be added and existing steps, stages, and/or processes can be removed.

In some embodiments, the method 200 can optionally include downloading 202 and installing the client application 122 onto the client device 104. The client application 122 can be downloaded from the insurance server system 102 or from another third-party application provider such as an application store (e.g., GOOGLE PLAY, APPLE APPSTORE, etc.). The client application 122 can commence execution within a container 124 in some embodiments. In some embodiments, the remaining steps of the method 200 can be executed by the installed instance of the client application 122 on the client device 104. In some embodiments, one or more of the steps of the method 200 can be executed on one or more remote computer systems, such as the insurance server system 102. In some embodiments, the client application 122 can be previously installed on the client device 104.

The method 200 can include starting a field inspection 204, such as in response to a user opening the client application 122 and selecting an interface element corresponding to starting a field inspection. For example, a user of the client device 104 can select an interface element to initiate the field inspection.

The method 200 can include capturing 206 basic information. The basic information or data can be captured by the client device 104 using any form of input device or process. For example, the basic information can be input by voice-to-text, receiving typed characters, uploaded files, optical character recognition performed on images stored on or captured by the client device 104, or other means. In embodiments, the basic information can include any relevant information about livestock or owners of the livestock undergoing the field inspection. For example, the basic information can include a name of the individual or entity that owns the livestock and an address (coordinates, address, political or geographic unit, etc.) of the facility (farm, ranch, feed lot, etc.) where the livestock is located. In some embodiments, the basic information can be captured by reading and/or scanning a secure token or other electronic storage device, held by the owner or operator of the facility, that stores the basic information of the facility.

The method 200 can include capturing 208 images of the facility at which the livestock is housed. In some embodiments, the images can be captured using a camera of the client device 104 and/or another image capture device that communicates with the client device 104. In some embodiments, the images can have previously been captured and uploaded to the client device 104 in step 208. In embodiments, the images of the facility can include any images of the structures, machinery, grounds, and the like at the facility. For example, images can be captured of fields, fencing, enclosures, equipment (e.g., chute, squeeze chute, ramp, feeding system, watering system, milking system, etc.), and the like.

In some embodiments, capturing 208 images can be accompanied by capturing 210 geolocation data. For example, GPS coordinates of the client device 104 can be captured and stored at the time of image capture of a particular image. The GPS coordinates can be associated with each corresponding image captured.

The method 200 can include capturing 212 images of livestock at the facility. In some embodiments, the images can be captured using a camera of the client device 104 and/or another image capture device that communicates with the client device 104. In some embodiments, the images can have previously been captured and uploaded to the client device 104 in step 208.

In embodiments, capturing 212 an image of an item of livestock (i.e., a specific animal) can be accompanied by the determination of an identifier of the item of livestock. In embodiments, the identifier can uniquely identify the item of livestock that is represented in the captured image. In some embodiments, the identifier of the item of livestock can be entered in the client device 104 using inputs 116 of the client device 104 (in 216). In some embodiments, the identifier can be captured by analyzing the image of the item of livestock to identify characters, a bar code, a quick response (QR) code, or other symbol contained in the image. An item of livestock can also be identified by image analysis, e.g., comparing a captured image to a previously captured image and identifying a match based on matching visual attributes. For example, a machine learning model can be trained to match an item of livestock in a first image to the same item of livestock in one or more previously captured images. In some embodiments, the client application 122 can perform the image analysis. In some embodiments, the insurance server system 102 can perform the image analysis.

Capturing 212 the image of an item of livestock can be accompanied by capturing 214 geolocation data for each image of an item of livestock. For example, GPS coordinates of the client device 104 can be captured and stored at the time of image capture of an item of livestock. The GPS coordinates can be associated with each corresponding image captured.

The method 200 can further include receiving data 216 for each item of livestock. The data for an item of livestock can include the identifier (serial number, name etc.) for the item of livestock, breed, health history, immunization history, and/or other information. This information can be input by voice-to-text, receiving typed characters, uploaded files, optical character recognition performed on images stored on or captured by the client device 104, or other means.

In embodiments, the data can be captured for each animal at the time of image capture (step 212) or before or after image capture at step 212. In some embodiments, for example, a user can select an identifier from a list of identifiers using the client application 122 and then capture an image of an item of livestock such that the image will be associated with the identifier and any of the other above-described items of information for the item of livestock. In some embodiments, for example, the data for an item of livestock can be associated with an image of the item of livestock by relating the image to an identifier included in the data using the machine learning approach described above.

The method 200 can include evaluating 218 whether the client device 104 has a network connection to the insurance server system 102. If so, the information captured at steps 206-216 can be transmitted 220 to the insurance server system 102. In embodiments, the client application 122 can transform and arrange the information captured in a format that is compatible with the insurance server system 102. For example, the client application 122 can format the captured information in the form of a portable document format (PDF) file. The captured images from steps 208 and 212 can also be included in the PDF file.

If not, the information captured at steps 206-216 can be stored 222 on the client device 104, such as in a persistent storage device including a NAND flash drive, hard disk drive, or other persistent storage device. In some embodiments, if the information is stored 222, the user can be notified one or more times (e.g., periodically) to connect to the network 106 and upload the information. For example, upon opening the client application 122, the client application 122 can notify the user if any captured information remains to be uploaded and present an interface element to invoke upload. In some embodiments, upon detecting a connection to the network 106, the information is automatically uploaded without further action by the user.

Once transmitted to the insurance server system 102, the information captured at steps 206-216 can be stored in a database for automated or human review in order to issue insurance for the livestock processed according to the method 200. The database can be a database according to GOOGLE FIREBASE, ORACLE, SQL, MYSQL, DB2, or other database technology. In some embodiments, the server system 102 includes or is implemented as a GOOGLE FIREBASE server or other type of database server.

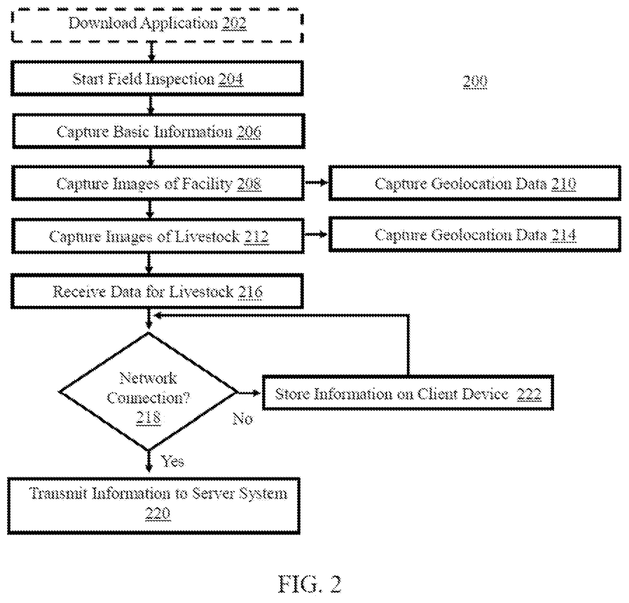

FIG. 3 illustrates a method 300 for creating claims for loss of one or more items of livestock. While FIG. 3 illustrates several steps, stages, and/or processes that can be performed in method 300, the steps, stages, and/or processes can be performed in any order, and additional steps, stages, and/or processes can be added and existing steps, stages, and/or processes can be removed.

The method 300 can optionally include downloading 302, installing, and initiating execution of the client application 122 on the client device 104, or whichever of these steps has not been previously performed.

The method 300 can include starting 304 a claim inspection. In an embodiment, the claim inspection can begin in response to a user opening the client application 122 and selecting an interface element corresponding to starting a claim inspection. In response, the client application 122 can generate interfaces for the claims inspection.

The method 300 can include capturing 306 basic information. In embodiments, the basic information can have been previously captured in a previous iteration, for example, during the process of the method 200. In embodiments, the basic information can be captured similarly to the processes described above in 206 of method 200.

The method 300 can include capturing 308 images relevant to the livestock claim. As described herein, a “livestock claim” can be a request that insurance provide compensation for an event associated with one or more items of livestock. For example, a “livestock claim” can be a request for payment on an insurance policy for an item of livestock that has perished. In embodiments, one or more images can be captured that are relevant to the livestock claim. The one or more images can include images of a carcass of the item of livestock, images of an enclosure or portion of a field where the carcass was found, images of injuries or externally visible symptoms on the carcass, or any other images deemed relevant by the user or required by the insurer.

In some embodiments, capturing 308 images can be accompanied by capturing 310 geolocation data. For example, GPS coordinates of the client device 104 can be captured and stored at the time of image capture of a particular image. The GPS coordinates can be associated with each corresponding image captured.

The method 300 can include receiving 312 a description of livestock claim events. This can include receiving the description as a video or voice recording or narrative text. Receiving 312 the description can additionally or alternatively include receiving selection of predefined options as part of an automated interview or questionnaire. In some embodiments, receiving 312 the description can be accompanied by capture of geolocation data, e.g., GPS coordinate of the client device 104 at the time of receiving 312 the description. The method 300 can further include presenting terms and conditions and receiving 316 acceptance of those terms and conditions.

After some or all of the information of steps 306-316 is collected, the method 300 can include evaluating 318 whether the client device 104 has a connection to the network 106. For example, the evaluation 318 can be performed while the information is collected at steps 306-316 and information can be transmitted 322 to the insurance server system 102 after each step 306-316 or multiple steps of the steps 306-316 if a network connection is found 318. Alternatively, the evaluation 318 can be performed after all of steps 306-316 are performed. If a network connection is found 318, the information from some or all of steps 306-316 is transmitted 322 to the insurance server system 102.

If the client device 104 is found 318 to not have a network connection, the method 300 can include storing 320 the information on the client device 104. In some embodiments, if the information is stored, the client can be notified one or more times (e.g., periodically) to connect to the network 106 and upload the information. For example, upon opening the client application 122, the client application 122 can notify the user if any captured information remains to be uploaded and present an interface element to invoke upload. In some embodiments, upon detecting a connection to the network 106, the information is automatically transmitted 322 without further action by the user.

In embodiments, the client application 122 can display 324 a claim status in a dashboard interface following transmission 322 of the claim information. For example, a user can open the client application 122 and request to view the dashboard and select a reference to a claim in order to view some or all of the information from steps 306-316 and view any information received from the insurance server system 102 with respect to the claim.

In some embodiments, the client application 122 can present information from the insurance server system 102. For example, content, such as newsletters, educational videos, or other content. The content can be for the purpose of helping a user to reduce risk to livestock and/or learn how to use the client application 122 effectively. Accordingly, such content can be displayed on the client device 104, such as in response to a user input requesting the display of the content.

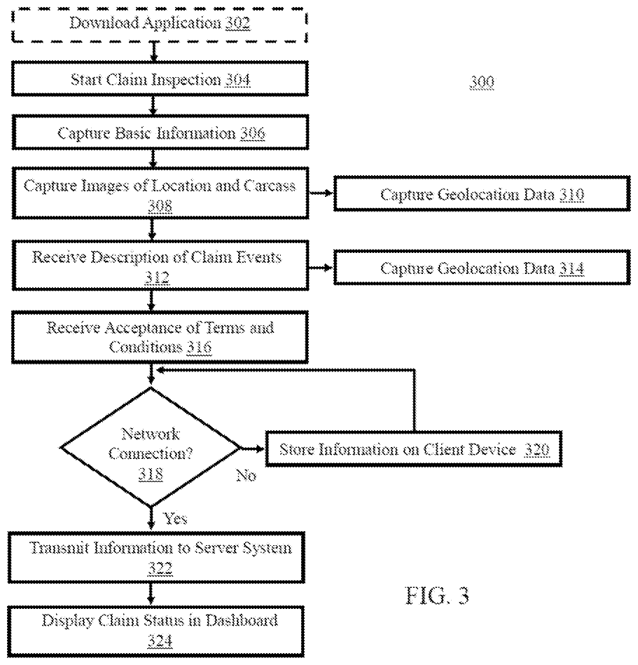

FIG. 4 illustrates components of the client application 122 that can be used to support intake of livestock data and claims. While FIG. 4 illustrates various components included in the client application 122, additional components can be added and existing components can be removed.

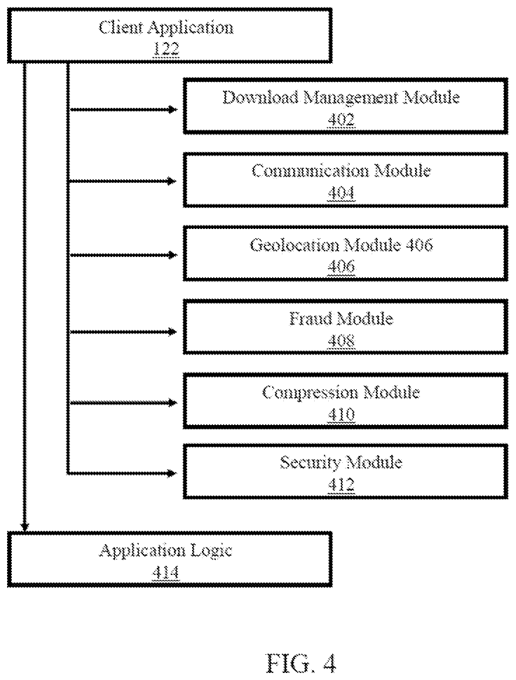

The client application 122 can include a download management module 402. The download management module 402 can be operated to configure the application 122 upon download and installation. An example method that can be performed by the download management module 402 is described below with respect to FIG. 5.

The client application 122 can include a communication module 404. The communication module 404 can establish network connections to the insurance server system 102 over the network 106. The communication module 404 can further evaluate whether a network connection exists and the status of any network connection. In some embodiments, the communication module 404 can be configured to establish and manage one or more secure connections over the network 106 to the insurance server system 102 using public and private key encryption processes.

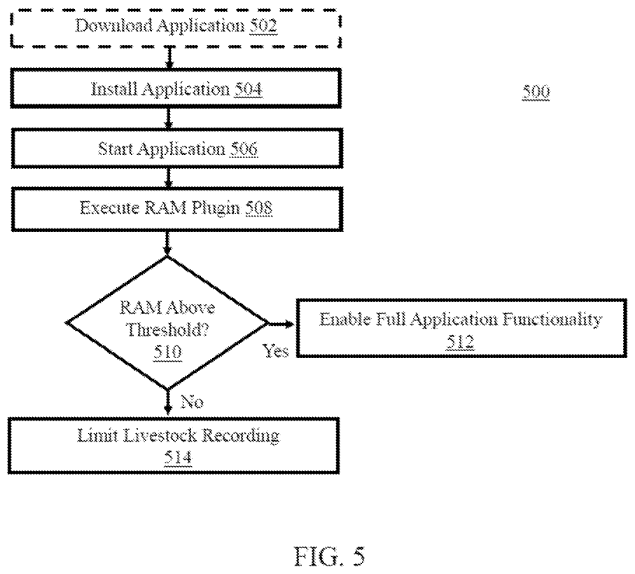

The client application 122 can include a geolocation module 406. The geolocation module 406 can capture the location of the client device 104 and associate the location with data captured by the client device. The location can be obtained from a GPS receiver of the client 104 or other means. An example method that can be performed by the geolocation module 406 is described below with respect to FIG. 6.

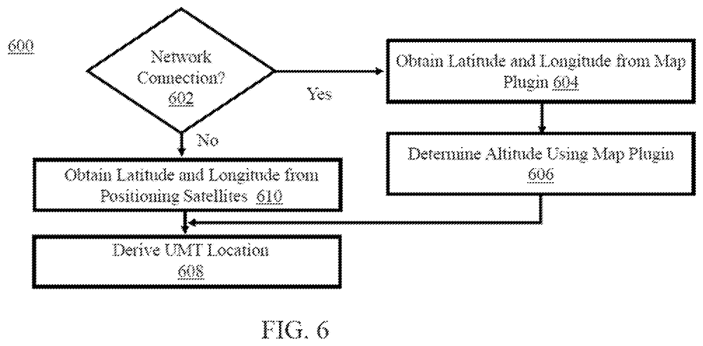

The client application 122 can include a fraud module 408. The fraud module 408 can ensure that livestock and claim data is input in an authenticated manner such that fraud is reduced. An example method that can be executed by the fraud module 408 is described below with respect to FIG. 7.

The client application 122 can include a compression module 410. The compression module 410 can compress data captured according to the method 200 and/or 300 prior to storage and transmittal. In particular, images and/or video data can be compressed. For example, data required to store an image can be reduced by 30 percent by reducing the quality of the image. The data required to store an image can be further reduced by performing compression. In some embodiments, the reduced quality image is added to a PDF document along with text data, and the PDF document is then compressed.

The client application 122 can include a security module 412. The security module 412 can authenticate the user of the client application 122, such as by receiving a username and password that are verified with the insurance server system 102. The security module 412 can further verify the authenticity of the insurance server system 102, such as using tokens, certificates, private and public keys, or any other type of authentication. The security module 412 can further establish an encrypted connection with the insurance server system 102 and manage the encryption of data sent to the insurance server system 102 and the decryption of data received from the insurance server system 102.

The client application 122 can further include application logic 414. The application logic 414 can implement the methods 200 and 300 as described herein and other functionality ascribed herein to the client application 122.

FIG. 5 illustrates a method 500 that can be executed on the client device 104 some or all of the method 500 can be executed by the download management module 402. While FIG. 5 illustrates several steps, stages, and/or processes that can be performed in method 500, the steps, stages, and/or processes can be performed in any order, and additional steps, stages, and/or processes can be added and existing steps, stages, and/or processes can be removed.

The method 500 can optionally include downloading 502 the client application 122 onto the client device 104, installing 504 the client application 122 on the client device 104, and starting 506 execution of the client application 122.

Upon starting, the client application 122 can evaluate 510 the amount of random-access memory (RAM) on the client device 104. This can include executing a plugin 508 on the client device 104, the plugin 508 can be programmed to evaluate the amount of RAM on the client device 104. If the amount of RAM is found to be above a threshold, then the full functionality of the client application 122 is enabled 512. If not, then the functionality of the client application 122 is limited 514 relative to the full functionality. For example, this can include imposing a limit on a number of items of livestock for which data can be input according to the method 200. In one example, if a device has more than 3 GB of RAM, full functionality of the client application 122 is enabled 512.

If not, the client application 122 is limited to 10 items of livestock (e.g., cows). The illustrated example is just one possible configuration. Other memory thresholds and limits can be used for different devices. There can be a practical limit on the number of items of livestock even if the full functionality of the client application 122 is enabled and which is greater than the limit imposed at step 514.

FIG. 6 illustrates a method 600 for encoding the geolocation data captured along with data according to the method 200 and 300 (see steps 210, 214, 310, and 314 described above). While FIG. 6 illustrates several steps, stages, and/or processes that can be performed in method 600, the steps, stages, and/or processes can be performed in any order, and additional steps, stages, and/or processes can be added and existing steps, stages, and/or processes can be removed. In embodiments, the method 600 can be executed by the geolocation module 406.

The method 600 can include evaluating 602 whether the client device 104 has a connection to the network 106. If so, the latitude and longitude of the client device 104 are obtained 604 using a map plugin executing on the client device 104, such as the GOOGLE MAPS plugin. The map plugin can obtain the latitude and longitude of the client device 104 using a GPS receiver of the client device 104 either alone or in combination with map data received over the network 106. The map plugin can also be used to determine 606 the altitude of the client device 104, such as using map data relating altitude to longitude and latitude.

If the client device 104 is not found 602 to have a network connection, the method 600 can include obtaining 610 latitude and longitude of the client device using exclusively satellite data received by the client device 104, such as data from GPS satellites received by a GPS receiver of the client device 104. The method 600 can also use other data captured by the client device 104 to determine the latitude and longitude such as device travel history, velocity, acceleration, altitude, and the like. In either case, the method 600 can include translating 608 latitude and longitude values to Universal Transverse Mercator (UTM) coordinates.

FIG. 7 illustrates a method 700 for fraud prevention that can be executed by the fraud module 408. The method 700 can be executed as part of the methods 200 and 300, such as prior to capturing images according to the methods 200 and 300. While FIG. 7 illustrates several steps, stages, and/or processes that can be performed in method 700, the steps, stages, and/or processes can be performed in any order, and additional steps, stages, and/or processes can be added and existing steps, stages, and/or processes can be removed. The method 700 can be executed for each image captured or for multiple captured images.

The method 700 can include outputting 702 a request on the client device 104, the request instructing the user to take a picture with a camera of the client device 104. The request of step 702 can be output on the display 112 of the client device 104 in an interface including interface elements that, when selected by the user, invoke taking a picture with the camera. The method 700 can further include outputting 704 a request for permission to access the camera. The request of step 704 can be accompanied by an interface element that, when selected by the user, instructs the mobile operating system 120 to allow the client application 122 to access the camera.

The method 700 can further include disabling the client application 122 from uploading previously-stored images from the client device 104. Following steps 706, capture 708 can be performed as described above with respect to the methods 200 and/or 300. In particular, only images captured during execution of the method 200 or 300 can be permitted to be selected for capture in the methods 200 or 300. For example, the disabling of uploading of saved images can be momentarily suspended after an image is captured to permit upload of the image and then reimposed, for example disabling of uploading can be suspended for a 10, 50, or 100 ms window after an image is captured.

This constraint can ensure that previously-saved or potentially manipulated images are not captured as part of the methods 200 and 300. In addition, images captured using the methods 200 and 300 can be stored as base64 encoded text on the client device 104 and possibly in a document that is transmitted to the insurance server system 102. The base64 encoded text does not allow for modification other than to be replaced with base64 encoded text for a subsequently captured replacement image.

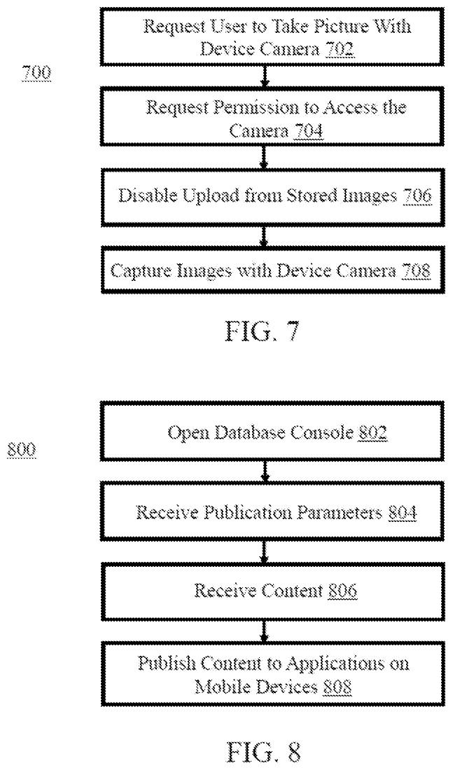

FIG. 8 illustrates a method 800 that can be executed on the insurance server system 102 in order to generate content to push to the client applications 122 executing on one or more client devices 104. While FIG. 8 illustrates several steps, stages, and/or processes that can be performed in method 800, the steps, stages, and/or processes can be performed in any order, and additional steps, stages, and/or processes can be added and existing steps, stages, and/or processes can be removed. The method 800 can include opening 802 a database console. For example, the console can be an interface to a FIREBASE, such as the FIREBASE command line interface (CLI). The remaining steps of the method 800 can be performed by means of interactions with the database console.

The method 800 can include receiving 804 publication parameters. The publication parameters can include a date and/or time of publication, a geographic region for publication, language, or one or more other filter criteria used to select who will receive the content. The method 800 can include receiving 806 the content, such as a selection of a file including a newsletter, video, or other content. The method 800 can then include publishing 808 the content to client applications 122 on one or more mobile devices in accordance with the parameters received at step 804, i.e. at a time and/or date specified in the parameters and to users satisfying one or more filter criteria specified in the parameters.

FIG. 9 illustrates an exemplary computing device 900 that can be used to implement the methods described herein. The computing device 900 can include one or more processing devices 902 configured to execute instructions with respect to data. For example, the one or more processing devices 902 can be central processing units (CPU), graphics processing units (GPU), application specific integrated circuits (ASICS), field programmable gate array (FPGA) or other type of processing device.

The one or more processing devices 902 can be connected to a bus 904, such as a peripheral connect interface (PCI) bus or other type of bus. A non-volatile storage device 906 and volatile memory 908 can be connected to the one or more processing devices 902, such as by means of the bus 904. The non-volatile storage device 906 can include a hard disk drive (HDD), solid state drive (SSD), or other type of non-volatile storage device. The volatile memory 908 can include a random-access memory (RAM), such as dynamic RAM (DRAM) or other type of RAM.

Other devices can be connected to the bus 904, such as a network interface 910 for connecting the computing device 900 to a wired or wireless network. A display device 912 can be connected to the bus 904, such as a screen, touch screen, projector, or other display device. One or more input devices 914 can be connected to the bus 904, such as a mouse, keyboard, trackpad, or other type of input device 914.

One or both of the non-volatile storage device 906 and volatile memory 908 can store executable code that, when executed by the one or more processing devices 902, causes the one or more processing devices 902 to perform the methods disclosed herein. The methods disclosed herein can be performed by a computer system including one or more computing devices 900. Where the computer system includes a plurality of computing devices 900, the plurality of computing devices 900 can be connected by a network or chassis backplane.

For purposes of illustration, programs and other executable program components are shown herein as discrete blocks, although it is understood that such programs and components can reside at various times in different storage components 906, 908 of computing device 900, and are executed by the one or more processing devices 902. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Memory in the processing devices 902 can be allocated dynamically according to variables, variable states, static objects, and permissions associated with objects and variables. Such memory allocation can be based on instructions stored in the memory devices, e.g., volatile memory 908 and/or non-volatile storage devices 906. Memory resources at a specific device can be conserved relative to other systems that do not associate variables and other objects with permission data for the specific device. The processing devices 902 can generate an output based on an input. For example, the processing device can receive an electronic and/or digital signal. The processing devices can read the signal and perform one or more tasks with the signal, such as performing various functions with data in response to input received by the processing device. The processing devices can read from memory devices, e.g., volatile memory 908 and/or non-volatile storage devices 906, information needed to perform the functions. For example, the processing devices 902 can update a variable from static to dynamic based on a received input and a rule stored as data on the memory device. The processing devices 902 can send an output signal to the memory devices, e.g., volatile memory 908 and/or non-volatile storage devices 906, and the memory device can store data according to the signal output by the processing device.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which can be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that can include: A alone; A and B; A, B and C; A, B, C, and D; and so forth. The bounds of an “and/or” list are defined by the complete set of combinations and permutations for the list.

It will be appreciated by those skilled in the art that changes could be made to the various aspects described above without departing from the broad inventive concept thereof. It is to be understood, therefore, that the subject application is not limited to the particular aspects disclosed, but it is intended to cover modifications within the spirit and scope of the subject application as disclosed above and claimed.

1. A method comprising:
receiving, by a client application executing on a mobile computing device, livestock information, the livestock information comprising one or more of information about a livestock facility or information about items of livestock at the livestock facility;
capturing, by the client application, images of the items of livestock at the livestock facility;
determining an identification of one of the items of livestock based at least partially on an analysis of one or more of the images that were captured; and
transmitting, by the client application, the livestock information, the images to an insurance server system, and the identification.

2. The method of claim 1, wherein determining an identification comprises:
transmitting the one or more of the images to the insurance server system; and
receiving, from the insurance server system, the analysis of the one or more images.

3. The method of claim 1, further comprising:
(a) determining, by the client application, that the mobile computing device is not connected to a network;
in response to (a), storing, by the client application, the livestock information and the images on the mobile computing device;
(b) determining, by the client application, that the mobile computing device has connected to the network; and
transmitting the livestock information and the images to the insurance server system is in response to (b).

4. The method of claim 1, wherein transmitting the livestock information and the images to the insurance server system comprises:
transmitting a document including the livestock information and the images; and
wherein the document is a portable document format (PDF) document.

5. The method of claim 4, wherein transmitting the images to the insurance server system comprises:
processing the images to obtain reduced quality images and transmitting the reduced quality images to the insurance server system.

6. The method of claim 5, wherein the reduced quality images are included in the document as base64 encoded text.

7. The method of claim 1, wherein capturing the images of the items of livestock comprises:
disabling, by the client application, upload of images stored on the mobile computing device; and
capturing, by the client application, the images of the items of livestock while upload of images stored on the mobile computing device is disabled.

8. The method of claim 1, further comprising:
evaluating, by the client application, an amount of memory available on the mobile computing device;
(a) determining, by the client application, that the amount of memory is less than a threshold; and
in response to (a), limiting, by the client application a number of items of livestock that can be referenced by the livestock information and the images.

9. The method of claim 1, further comprising:
capturing a location of the mobile computing device while capturing the images of the items of livestock.

10. A non-transitory computer-readable medium storing executable code that, when executed by one or more processing devices causes the one or more processing devices to:
receive, by a client application, livestock information;
initiate capture of images of livestock referenced by the livestock information;
in response to initiating capture, disabling, by the client application, upload of stored on a mobile computing device to the client application;
capture, while image upload is disabled, images of livestock referenced by the livestock information; and
transmit, by the client application, the livestock information and the images to an insurance server system.

11. The non-transitory computer-readable medium of claim 10, wherein the executable code, when executed by the one or more processing devices further causes the one or more processing devices to:
(a) determine, by the client application, that the one or more processing devices are not connected to a network;
in response to (a), store, by the client application, the livestock information and the images referenced by the livestock information on a storage device connected to the one or more processing devices;
(b) determine that the one or more processing devices are connected to the network; and
transmit the livestock information and the images to the insurance server system in response to (b).

12. The non-transitory computer-readable medium of claim 10, wherein the executable code, when executed by the one or more processing devices further causes the one or more processing devices to transmit the livestock information and the images to the insurance server system by transmitting a document including the livestock information and the images; and
wherein the document is a portable document format (PDF) document.

13. The non-transitory computer-readable medium of claim 12, wherein the executable code, when executed by the one or more processing devices further causes the one or more processing devices to transmit the images to the insurance server system by processing the images to obtain reduced quality images and transmitting the reduced quality images to the insurance server system.

14. The non-transitory computer-readable medium of claim 13, wherein the reduced quality images are included in the document as base64 encoded text.

15. The non-transitory computer-readable medium of claim 10, wherein the executable code, when executed by the one or more processing devices further causes the one or more processing devices to:
evaluate, by the client application, an amount of memory available on a mobile computing device including the one or more processing devices; and
if the amount of memory is less than a threshold, limit a number of items of livestock that can be referenced by the livestock information and the images.

16. The non-transitory computer-readable medium of claim 10, wherein the executable code, when executed by the one or more processing devices further causes the one or more processing devices to capture a location of a mobile computing device while capturing the images of the livestock referenced by the livestock information, the one or more processing devices being included in the mobile computing device.

17. A mobile client device, comprising:
a communication device for communicating with an insurance server system via a network;
one or more memory devices storing instructions; and
one or more processing devices that execute the instructions to perform a method comprising:
receiving livestock information, the livestock information comprising one or more of information about a livestock facility or information about items of livestock at the livestock facility;
capturing, by an image capture device, images of the items of livestock at the livestock facility;
securely encoding the images of the items of livestock, wherein the encoding prevents alteration of the images; and
transmitting, via the network, the livestock information and the images to the insurance server system.

18. The mobile client device of claim 17, wherein the one or more processing devices execute the instructions to perform the method further comprising:
disabling, during capture of the images, upload of images stored on the one or more memory devices; and
disabling, during capture of the images, the communication device.

19. The mobile client device of claim 17, wherein the one or more processing devices execute the instructions to perform the method further comprising:
determining an identification of one of the items of livestock based at least partially on an analysis of one or more of the images that were captured.

20. The mobile client device of claim 17, wherein the one or more processing devices execute the instructions to perform the method further comprising:
(a) determining that communication on the network is not available;
in response to (a), storing, by the client application, the livestock information and the images on the one or more memory devices;
(b) determining, by the client application, that communication on the network is available; and
transmitting the livestock information and the images to the insurance server system is in response to (b).
